(19) United States
(12) Patent Application Publication
(10) Pub. No.: US 2007/0174864 A1
(43) Pub. Date: Jul. 26, 2007

(54) Coder/decoder enabled television

(75) Inventor: Ismael N. Castillo, Round Rock, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/338,976

(22) Filed: Jan. 25, 2006

(51) Int. Cl. H04N 7/16

(52) U.S. Cl. 725/25

(57) ABSTRACT

Exemplary embodiments include a coder/decoder-enabled television including: a processor executing a coder/decoder routine; a display device in electrical communication with the processor; a media input in electrical communication with the processor; a communications port in electrical communication with the processor; and wherein the processor receives a media signal from the media input and responsively transmits a display signal the display device, the processor encoding the media signal to provide a monitoring signal and providing the monitoring signal to the communications port.

IBM ® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This invention relates generally to a coder/decoder-enabled television, and in particular to a coder/decoder-enabled television that provides media to a client device over a network.

2. Description of Background

Television has long been considered to have a significant influence on children. Television programming offers some programming that is only suitable for “mature” audiences. Parents are not always able to know what their children are watching and typically do not have the time to ensure that their child is watching only what the parent considers to be suitable.

U.S. Pat. No. 6,331,877, “Electronic Television Program Guide Schedule System and Method,” discloses a method of blocking undesired television programming. The '877 patent uses an on-screen menu to block particular television shows according to the channel they are on, their Motion Picture Association of America (MPAA) rating, or their parental guidance indicators (i.e. violence, nudity, adult situations, etc.). However, a need exists beyond the '877 patent for a method that allows a parent to review the television programming that has actually been viewed when the parent is not present.

U.S. Pat. No. 6,321,381, “Apparatus and Method for Improved Parental Control of Television Use,” also discloses a method of blocking undesired television programming. The '381 patent uses a parental ID and an on-screen menu to block specific television programs. However, a need exists beyond the '381 patent for a method that allows a parent to review the television programming that has actually been viewed in their absence.

U.S. Pat. No. 6,094,194, “Apparatus and Method of Providing a Controller for Selective Blocking of Cable Television Programming,” discloses a method for blocking undesired television content. In the '194 patent, the cable box connected to the television is locked inside the invention. The user then interfaces with the cable box through the invention, so that the user can block unwanted television programming. However, what is needed beyond the '194 patent is a method of monitoring the programming actually viewed and that is not dependent on the use of a cable box.

More recently, the V-Chip has gained popularity as an effective method of blocking television programming based on MPAA ratings, age restrictions, or content. However, the v-chip is only a method of blocking either channels or programs from viewing; no mechanism is provided so that the parent can determine what programs the children are watching. The V-Chip, and indeed all the prior art that address the problem of restricted viewing, focus on the act of how to stop the programming from appearing on the television screen. The V-Chip and the prior art attempt to prevent the child from viewing the unwanted programs, a need exists for a “trust, but verify” method of parenting that allows parents to trust their children with unrestricted access, but that also allows them to verify that their trust is warranted.

### SUMMARY

Exemplary embodiments include a coder/decoder-enabled television including: a processor executing a coder/decoder routine; a display device in electrical communication with the processor; a media input in electrical communication with the processor; a communications port in electrical communication with the processor; and wherein the processor receives a media signal from the media input and responsively transmits a display signal the display device, the processor encoding the media signal to provide a monitoring signal and providing the monitoring signal to the communications port.

Other exemplary embodiments also include a remote monitoring system including: a coder/decoder-enabled television in electrical communication with a communications network, the coder/decoder-enabled television including: a processor executing a coder/decoder routine; a display device in electrical communication with the processor; a media input in electrical communication with the processor; a communications port in electrical communication with the processor; and wherein the processor receives a media signal from the media input and responsively transmits a display signal the display device, the processor encoding the media signal to provide a monitoring signal and providing the monitoring signal to the communications port; and a remote device in electrical communication with the communications network wherein the remote device receives the monitoring signals from the coder/decoder-enabled television.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which allows a user to remotely monitor and control the media being displayed on a coder/decoder-enabled television.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of coder/decoder-enabled television; and

FIG. 2 illustrates an exemplary embodiment of a remote monitoring system including a coder/decoder-enabled television.

The detailed description explains the preferred embodiments of the invention, together with advantages and features, by way of example with reference to the drawings.

### DETAILED DESCRIPTION

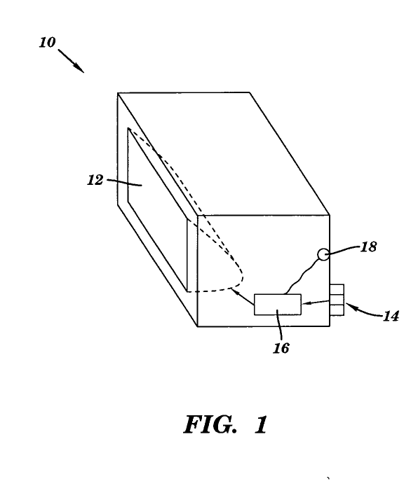

Referring now to FIG. 1, an exemplary embodiment of a coder/decoder-enabled television is generally depicted as 10. The coder/decoder-enabled television 10 includes a display device 12, a media input 14, a processor 16, and a communications port 18. The display device 12 can include various types of display devices including, but not limited to, a Cathode-Ray Tube (CRT) display, a Liquid Crystal Display (LCD), a Plasma display, an Electroluminescent (EL) display, or the like. The display device 12 is in electrical communication with the processor 16, which processes media signals received from the media input 14 and responsively transmits display signals to the display device 12. The media input 14 can include various types of inputs including, but not limited to, s-video cable, coaxial cable, component video cable, HDMI video cable, DVI video cable, and the like. The processor 16 is also in electrical communication with the communications port 18.

In exemplary embodiments, the processor 16 is designed to handle a variety of media signals and formats including, but not limited to those specified by the Advanced Television Systems Committee (ATSC) and the National Television Systems Committee (NTSC). Furthermore, the processor 16 is designed to process various types of media signals including, but not limited to, 480i, 480p, 720p, 1080i, and 1080p signal types. In addition to processing the media signals and transmitting the display signals, the processor 16 also generates and transmits a monitoring signal to the communications port 18. The monitoring signal is a compressed and optionally encoded version of the display signal that is transmitted to the communications port 18. In exemplary embodiments, the communications port 18 may be connected to a variety of communications networks including, but not limited to, a plain old telephone service (POTS), a broadband Internet connection through a cable modem or DSL line, a local area network (LAN), or a wireless communications network.

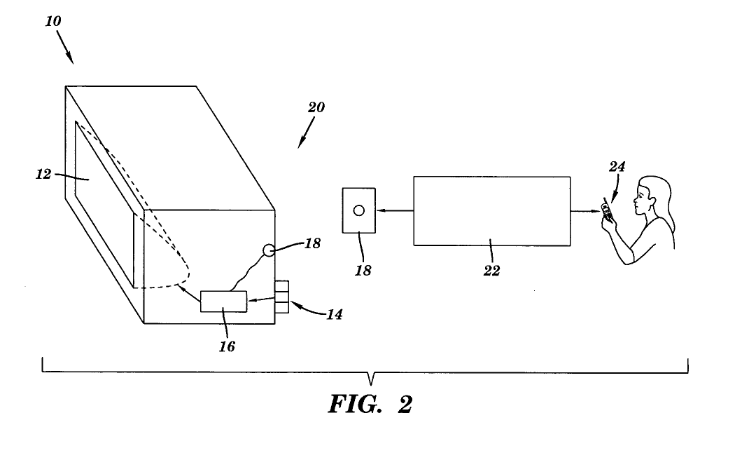

Continuing now with reference to FIG. 2, an exemplary embodiment of a remote monitoring system 20 including a coder/decoder-enabled television 10 is depicted. The remote monitoring system 20 also includes a communications network 22 in electrical communication with the coder/decoder-enabled television 10 and a remote device 24. The remote device 24 can be any remote communications device that has a display and may include, but is not limited to, a cellular phone, a laptop, a PDA, a Blackberry™, or the like. In exemplary embodiments, the remote device 24 establishes a connection to the coder/decoder-enabled television 10 over the communications network 22 and receives the monitoring signals transmitted by the coder/decoder-enabled television 10. In one embodiment, the user of the remote device 24 may dial a telephone number of the phone line that the coder/decoder-enabled television 10 is connected to thereby establishing a communications session between the remote device 24 and the coder/decoder-enabled television 10. In other embodiments, the coder/decoder-television 10 may be connected to a broadband network and may have an associated IP address that the remote device 24 may contact to establish the connection between the remote device 24 and the coder/decoder-enabled television 10.

The remote device 24 decodes and/or decompresses the monitoring signals and displays, on the remote device 24, what is currently being displayed on the display device 12 of the coder/decoder enabled television 10. The processor 16 may use various CODECs depending upon the type of communications network 22 the coder/decoder-enabled television 10 and the remote device 24 are connected to. As used herein a CODEC is a technology for compressing and decompressing images and sound that defines the video settings such as the frame rate and size. For example, the processor 16 may correlate the compression ratio of the monitoring signal with the available bandwidth of the communications network 22 (e.g., a higher bandwidth communications network would require less compression of the media signal). In exemplary embodiments, the processor 16 may employ various CODECS that are well known including, but not limited to, .ASF, .AVI, .MPEG, .QT, .MOV, and .RA.

In an exemplary embodiment, the communications port 18 is a modem connected to the communications network 22, a POTS network, and the remote device 24 is a cellular telephone. The cellular telephone is used to establish a secure connection to the coder/decoder-enabled television 10 through the modem. In exemplary embodiments, an authentication process may be used by the modem to restrict access to the coder/decoder-enabled television 10. Various authentication methods may be used including, but not limited to, a user-supplied password, restricting access to specific incoming telephone numbers verified through a caller identification system (CID), and the like.

In exemplary embodiments, the remote monitoring system 20 allows a user to monitor what is being displayed on the display device 12 of the coder/decoder-enabled television 10 regardless of the source of the media that is being displayed. For example, the source of the media can include, but is not limited to, a DVD player, a VHS player, a cable box, a satellite receiver, a digital video recorder, or the like. Since the processor 16 generates and transmits both the display signals and the monitoring signals, the source of the media signals received by the processor does not affect the operation of the remote monitoring system 20.

In exemplary embodiments, the remote device 24 can be used to control the coder/decoder-enabled television 10. The remote device 24 may be used to selectively disable the display device 12, change the channel of the coder/decoder-enabled television 10, turn on or off the coder/decoder-enabled television 10, lock a specific channel in the coder/decoder-enabled television 10, send text messages to the coder/decoder-enabled television 10, or other control functions. In yet further exemplary embodiments, the remote device 24 may include a camera and may be capable of transmitting a picture to the coder/decoder-enabled television 10, which in turn can display the picture on the display device 12. Using these functions a user can not only monitor the media being displayed on the coder/decoder-enabled television 10 but also control the coder/decoder-enabled television 10. For example, a parent could check to see what their children are watching and if they do not approve they can change the channel or turn off the coder/decoder-enabled television 10 for a specific period of time when, then for the coder/decoder-enabled television 10 to be turned on a security code will be required. In one embodiment, the coder/decoder-enabled television 10 may include a safety interlock that prevents the use of the coder/decoder-enabled television 10 unless the communications port 18 is connected to a communications network 22.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A coder/decoder-enabled television comprising:
a processor executing a coder/decoder routine;
a display device in electrical communication with the processor;
a media input in electrical communication with the processor;
a communications port in electrical communication with the processor; and
wherein the processor receives a media signal from the media input and responsively transmits a display signal the display device, the processor encoding the media signal to provide a monitoring signal and providing the monitoring signal to the communications port.

2. The coder/decoder-enabled television of claim 1, wherein the communication port is a modem.

3. The coder/decoder-enabled television of claim 2, wherein the display device is at least one of the following:
an LCD;
a plasma display; and
a CRT display.

4. The coder/decoder-enabled television of claim 1, wherein the communications port transmits a control signal to the processor.

5. A remote monitoring system comprising:
a coder/decoder-enabled television in electrical communication with a communications network, the coder/decoder-enabled television comprising:
a processor executing a coder/decoder routine;
a display device in electrical communication with the processor;
a media input in electrical communication with the processor;
a communications port in electrical communication with the processor; and
wherein the processor receives a media signal from the media input and responsively transmits a display signal the display device, the processor encoding the media signal to provide a monitoring signal and providing the monitoring signal to the communications port; and
a remote device in electrical communication with the communications network wherein the remote device receives the monitoring signals from the coder/decoder-enabled television.

6. The remote monitoring system of claim 5, wherein the remote device includes a display.

7. The remote monitoring system of claim 6, wherein the remote device displays the media currently being displayed on the display device.

8. The remote monitoring system of claim 7, wherein the remote device transmits a control signal to the coder/decoder-enabled television.

9. The remote monitoring system of claim 5, wherein the communications network is an IP network.

10. The remote monitoring system of claim 5, wherein a communications session is established between the remote device and the coder/decoder-enabled television.

11. The remote monitoring system of claim 10, wherein the communications session is established by the remote device connecting to a phone line that is connected to the coder/decoder-enabled television.

12. The remote monitoring system of claim 10, wherein the communications session is established by the remote device connecting to an IP address corresponding to the coder/decoder-enabled television.
